(19) United States
(12) Patent Application Publication
(10) Pub. No.: US 2012/0291089 A1
(43) Pub. Date: Nov. 15, 2012

(54) METHOD AND SYSTEM FOR CROSS-DOMAIN DATA SECURITY

(75) Inventors: Clay D. Bomgardner, Mruphy, TX (US); Kimbry L. McClure, Garland, TX (US)

(73) Assignee: Raytheon Company, Waltham, MA (US)

(21) Appl. No.: 13/107,106

(22) Filed: May 13, 2011

(51) Int. Cl. G06F 21/00

(52) U.S. Cl. 726/1; 726/26

(57) ABSTRACT

A data management system includes a microprocessor and a data manager executing on the microprocessor. The data manager is communicatively coupled to a first domain and a second domain and includes a first domain security process associated with a first domain security policy and operable to provide access to first domain data based on the first domain security policy. The data manager further includes a second domain security process associated with a second domain security policy and operable to provide access to first domain data based on the second domain security policy.

### FIELD OF THE INVENTION

The inventive concepts, systems, and methods described herein are directed to data management and, more particularly, to cross-domain data management and security.

### BACKGROUND

As is known in the art, information assurance (IA) is the practice of managing security risks related to the use, processing, storage, and transmission of data and the systems and methods used for those purposes. IA has grown from the practice of data security which in turn grew out of the practices and procedures of computer security. One widely known IA model is the Confidentiality, Integrity, and Availability (C-I-A) Model which focuses on data confidentiality, data integrity and data availability. Security system engineers often use the C-I-A Model to help design and develop some of the important aspects of IA and data security management.

As is also known in the art, one type of IA solution is a cross-domain IA solution which enables two or more security domains (which are enclaves of secured servers and computers) to manually and/or automatically transfer data between domains. Typically, security domains must add and/or reconfigure existing servers, computers, and networking hardware/software to update/modify a cross-domain solution. As a result, it can be quite complex and challenging for security domains to manage, maintain, and upgrade cross-domain solutions and platforms, particularly for large-scale, dynamic installations intended to support data sharing and consumption across multiple organizations.

### SUMMARY OF THE INVENTION

In general overview, the inventive concepts, systems, and methods described herein enable a cross-domain security structure providing security mechanisms between multiple domains for data assurance, sharing and consumption. More particularly, features of the cross-domain security structure can include a data manager including security processes and associated security policies. Security processes and policies are associated with a security domain and are used to define and execute security mechanisms which the domain needs or desires.

Moreover, the data manager enables independent configuration of security processes and policies so that a particular security process or policy may be updated, tested, certified, etc. without requiring reconfiguration of other security processes or policies. Furthermore, the data manager may be configured independently of security processes or policies so that the data manager may be updated, tested, certified, etc. without requiring reconfiguration of the security processes or policies. Advantageously, the data manager can enable flexible, scalable, and dynamic security services across a variety of different environments including, but not limited to, large-scale, cross-domain computing environments involving multiple organizations.

The inventive concepts, systems, and methods enable domains (and more particularly, organizations in control of domains) to segregate security mechanisms and postures into separate security policies (for example, security policies for data confidentiality or data integrity or data availability, etc.). One or more of the domain security policies may then be certified, validated, and/or developed as needed or desired without impacting other domain security policies. This can lead to a so-called plug-and-play type security structure for cross-domain security management.

In one aspect, a data management system includes a microprocessor and a data manager executing on the microprocessor. The data manager is communicatively coupled to a first domain and a second domain and includes a first domain security process associated with a first domain security policy and operable to provide access to first domain data based on the first domain security policy and a second domain security process associated with a second domain security policy and operable to provide access to first domain data based on the second domain security policy.

In further embodiments, the data management system includes one or more of the following features: the first domain security policy is associated with first domain security information received from the first domain from a security process resident in the first domain; the second domain security policy is associated with second domain security information received from the second domain from a security process resident in the second domain; further including a data manager process communicatively coupled to the first domain process and the second domain process and configured to provide access to the first domain data based on a data manager security policy; the first domain security process includes a plurality of individually configured first domain security processes; the first domain security policy is related to the second domain security policy, and; the data manager provides data access to at least one of the first domain or the second domain.

In another aspect, a system includes a microprocessor and a data manager executing on the microprocessor and to couple of a first domain and a second domain. The data manager includes plurality of domain security processes to receive of a plurality of domain security policies associated with the first domain and to enable access to first domain data based on the plurality of domain security policies and a configuration process to configure the domain security processes independently of each other and to configure the data manager independently of the domain security processes.

In further embodiments, the system includes one or more of the following features: the configuration process enables update of one of the domain security processes without requiring reconfiguration of another domain security process; said domain security process update includes addition, deletion, or modification; the configuration process enables update of one of the domain security processes without requiring reconfiguration of the data manager; the domain security processes are first domain security processes and the domain security policies are first domain security policies, the data manager further including a plurality of second domain security processes to receive of a plurality of second domain security policies associated with the second domain and to enable access to first domain data based on the plurality of second domain security policies; one of the second domain security policies is related to one of the first domain security policies, and; the configuration process enables comparing of the related first and second domain security policies.

In a further aspect, a method includes configuring a data manager to enable data security between a first domain and a second domain, in the data manager, receiving a plurality of first domain security policies associated with the first domain, configuring the first domain security policies independently of each other and independently of said configuration of the data manager, and receiving first domain data and validating the first domain data based on the plurality of first domain security policies and rendering the first domain data to the second domain.

In further embodiments, the method includes one or more of the following features: said configuring the first domain security policies independently of each other includes adding, deleting, or modifying one of the first domain policies without requiring reconfiguration of another one of the first domain security policies; said configuring the first domain security policies independently of said configuring of the data manager includes adding, deleting, or modifying one of the first domain policies without requiring reconfiguration of the data manager; further including receiving a plurality of second domain security policies associated with the second domain, said validation of the first domain data further comprising validating the first domain data based on the plurality of second domain security policies, and; one of the second domain security policies is related to one of the first domain security policies, further including comparing configuration of the related first and second domain security policies.

### BRIEF DESCRIPTION OF THE DRAWINGS

The foregoing features of the inventive concepts, systems, and techniques described herein may be more fully understood from the following description of the drawings in which:

FIG. 1 is a block diagram of an embodiment of a data management system for cross-domain data security;

FIG. 2 is a block diagram depicting a more detailed embodiment of the system of FIG. 1;

FIG. 3 is a block diagram depicting an embodiment of comparison of related domain security policies.

FIG. 4 is a flow diagram of an embodiment of a method for cross-domain data security;

FIGS. 5A and 5B are flow diagrams of a particular operation of a cross-domain computing environment of the type which may incorporate the inventive concepts, systems, and methods described herein;

FIG. 6 is a diagram showing an exemplary hardware and operating environment of a suitable computer for use with embodiments of the invention.

### DETAILED DESCRIPTION

The term “domain” as used herein means a collection of data and assets under the control of an organization (or one or more groups in an organization). The organization uses domain data and assets to perform certain tasks and operations related to the organization. Domain data includes information that the organization needs or desires. Domain assets includes hardware and/or a combination of hardware and software assets the organization uses to access data including, but not limited to, computers, routers, switches, network hardware, and software to configure, secure and access data. Organizations can include federal, state, and local governments, commercial entities, or civic bodies.

A “domain security policy” as used herein means a rule to control and secure data access or data services. An organization can use one or more domain security policies to permit data access from other domains. Further, the organization can use a domain security policy related to data received from other domains. An organization can also use a domain security policy to secure domain data within the same domain. For example, one group within the domain can use a domain security policy before sharing data with another group within the domain. As non-limiting examples, domain security policies can be related to granting or denying data access or data services to users who may include users on different domains or within different groups of the same domain, data formatting, data review, data modification, data encryption, or anti-spam/anti-virus protection.

A “domain security process” enables and controls secure data access or data services from one domain to another domain as needed or desired. A domain security process executes one or more domain security policies. “Configuration” or “configuring” of a domain security process as used herein means updating domain security processes including adding, or deleting, or modifying domain security processes. More particularly, in some embodiments adding or modifying domain security processes can include certifying or verifying or accrediting or validating that certain domain security policies are properly enabled in a domain security process so that an organization can practice safe security techniques and postures.

In particular non-limiting examples, configuration of domain security processes (or data manager processes) can include adding domain security processes and certifying that domain security processes are compliant with certain predefined security standards and practices. This can include testing and validating that domain security processes operate within expected design parameters. In some embodiments, domain security processes can be tested by executing certain domain security policies related to data confidentiality, data integrity, and/or data availability. Domain security policies related to data confidentiality (for example, data encryption protocols) can be tested to ensure that confidential information is not disclosed to unauthorized individuals (or unauthorized domains). Domain security policies related to data integrity can be tested to ensure that unauthorized (and possibly undetectable) data modification does not occur across domains. Still further, domain security policies related to data service disruptions (for example, denial-of-service attacks) can be tested to ensure that data is readily available when (and where) it is needed or desired.

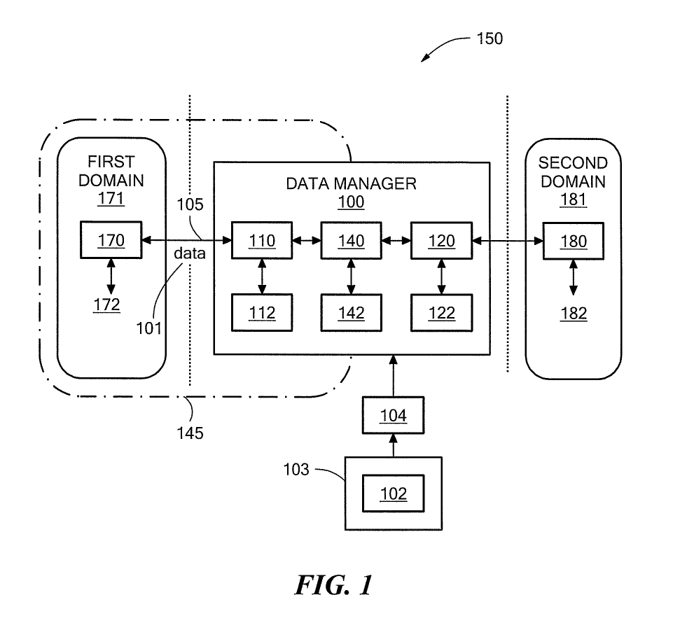

Referring to FIG. 1, in one aspect, a data management system 150 for cross-domain data management and security includes microprocessor 104 and data manager 100 executing on microprocessor 104. Data manager 100 is communicatively coupled to first domain 171 and second domain 181 and includes first domain security process 110 associated with first domain security policy 112 and operable to provide access to first domain data 101 based on first domain security policy 112. Data manager 100 further includes second domain security process 120 associated with second domain security policy 122 and operable to provide access to first domain data 101 based on the second domain security policy 122.

In some embodiments, data management system 150 includes instructions 102 stored in memory 103 that when loaded into and executed by microprocessor 104 enables data manager 100 for cross-domain data management and security. Data management system 150 may include hardware or a combination of hardware and software components to enable various features of data manager 100. For example, separate first domain security processes may execute on separate security microprocessors to facilitate independent configuration of first security processes as well as to promote fault tolerance.

In some embodiments, data manager 100 is communicatively coupled to multiple domains (for example, first domain 171 and second domain 181) over a network 105 which can include, but is not limited to, a wired network and/or a wireless network. Each domain may be configured in a separate security domain under the control of an organization. The organization uses security domain assets to secure the domain data. Domain data includes, but is not limited to, information such as an organization's business accounting information, security information such as user identifications, passwords, permissions, etc., and/or security process/service information. In some domains, data may be defined and stored in data files (i.e., text, audio, and video files). Data may be organized in a database controlled and accessed via a database management system.

Data manager 100 enables enforcement of security policies between multiple domains. As will be described further below, data manager 100 includes security processes (for example, first domain security process 110 and second domain security process 120) to enforce associated domain security policies (for example, first domain security policy 112 and second domain security policy 122) between first domain 171 and second domain 181. Data manager 100 may enable unidirectional data access from one domain to another domain (or from one domain to multiple domains) and/or bidirectional data access between domains. Optionally, data manager 100 may enable data access within the same domain, such as between different groups of an organization of first domain 171.

In some embodiments, first domain security process 110 and second domain security process 120 include hardware, software, and/or a combination of hardware and software components which enable secure data transfer/access or data services from one domain (for example, first domain 171) to another domain (for example, second domain 181). First domain security process 110 uses first domain security policy 112 to secure and process data 101 received from first domain 171. Data manger 100 may send some, all, or none of data 101 to second domain 181 based first domain security policy 112.

Furthermore, second domain security process 120 uses second domain security policy 122 to secure and process data 101 received from first domain 171 via first domain security process 110. Data manger 100 may send some, all, or none of data 101 to second domain 181 based second domain security policy 122. It should be noted that respective first domain security policy 112 and second domain security policy 122 enable data 101 to be secured according to security policies related to respective first domain 171 and second domain 181.

In a particular non-limiting example of a cross-domain computing environment of the type which may incorporate the inventive concepts, systems, and methods described herein, first domain security policy 112 includes rules to search for and remove sensitive information from data (which can include data 101) in accordance with the security needs or desires of first domain 171. In particular, data manager 100 can receive first domain security policy 112 from first domain 171. First domain security policy 112 can represent security practices of a first organization in control of first domain 171. Much in the same way, second domain security policy 122 (which data manager 100 receives from second domain 181) includes rules to search for and remove sensitive information from data (which can include data 101) in accordance with the security practices of a second organization in control of second domain 181. In this way, data manager 100 can enable access to data 101 based on security policies of multiple organizations each in control of separate domains (171, 181).

To continue with this particular example, first domain security process 110 can receive data 101, execute the rules in policy 112 and render the results. Second domain security process 120 can receive the results from first domain security process 110 and execute the rules in policy 122 to further search for and remove any sensitive information from rendered data.

In another particular non-limiting example, first domain security policy 112 defines procedures to format data in accordance with the security needs and desires of first domain 171 and second security policy 122 defines procedures to format data 101 in accordance with the security needs and desires of second domain 181. First domain process 110 receives data 101, formats data 101 according to policy 112 and renders the result. Second domain process 120 receives the result and applies second domain security policy 122 to further format the data.

It should be noted that domains (for example, first domain 171 and second domain 181) may have different security practices which may be defined as different sensitivity and/or formatting criteria in respective domain security policies (for example, respective first domain security policy 112 and second domain security policy 122). In a particular cross-domain computing environment involving data access between first domain 171 under the control of a private business and second domain 181 under the control of a public sector organization, first domain security policy 112 can include criteria to remove the business's confidential and/or competitive information from data 101 before sharing the data 101 with the pubic sector organization. Second domain security policy 122 can include less stringent checks (such as the removal of any personal identification information) which the public sector organization needs or requires. In this way, data manager 100 enables sharing of data 101 across the different domains in a secure fashion and, in particular, according to the needs and desires of the different organizations.

In some embodiments, a cross-domain authority may configure at least one first domain security policy 112 or second domain security policy 122 on data manager 100. Industry may mandate and setup the cross-domain authority to certify and validate security practices for data access and data services. Cross-domain authority may work with either one or both domains 171, 181 (and, in particular, with either one or both organizations in control of the domains) to configure, certify, and/or validate security on data manager 100.

In the same or different embodiment, data manager 100 includes data manager process 140 including at least one data manager security policy 142. Here, data manager security policy 142 includes security policies that may be needed or desired for cross-domain security, yet not specific to any particular domain or organization. To this end, the aforementioned cross-domain authority may mandate and govern data manager security policy 142.

As can be seen in FIG. 1, data manager 100 can enable a domain security boundary mechanism (as represented by dash-dot line box designated by reference numeral 145) between first domain 171 and second domain 181. Within the domain security boundary mechanism, data manager 100 can include first domain security process 110 and data manager process 140 to execute respective first domain security policy 112 specific to first domain 171 and data manager security policy 142 established (and mandated) for all domain data and services in a cross-domain computing environment.

In still a further embodiment, data manager process 140 includes an auditor which audits all data and security transactions which may occur on data manager 100. The auditor may collect and maintain cross-domain data (for example, by storing and updating the data in a central data repository) and cross-domain security transactions (for example, by storing and updating transactions in a security log).

In some embodiments, data manager 100 includes security policies associated with domain security information resident on a particular domain. Here, first domain security policy 112 is associated with first domain security information 172 received from a security process 170 resident in first domain 171. For example, first domain security information 172 may include certain security parameters for protecting and securing data and assets within first domain 171.

It may be said that security process 170 is configured to protect and secure data in first domain 171 (that is, intra-domain) based on first domain security information 172, whereas first domain security process 110 is configured to secure and protect data 101 across domains (that is, inter-domain) based on security policy 112. It should be noted that security process 170 and first domain security process 110 may enable similar security functions, although security rules defined for each may be different. For example, rules defined in first domain security policy 112 may be more rigorous than those defined in security information 172 since data manager 100 may render data 101 to potentially untrustworthy (or insecure) domains.

In the same or different embodiment, second domain security policy 122 is associated with second domain security information 182 received from a security process 180 resident in second domain 181. For example, second domain security information 182 may include certain security parameters for protecting and securing data and assets within second domain 181. Security process 180 is configured to protect and secure data in second domain 181 based on second domain security information 182.

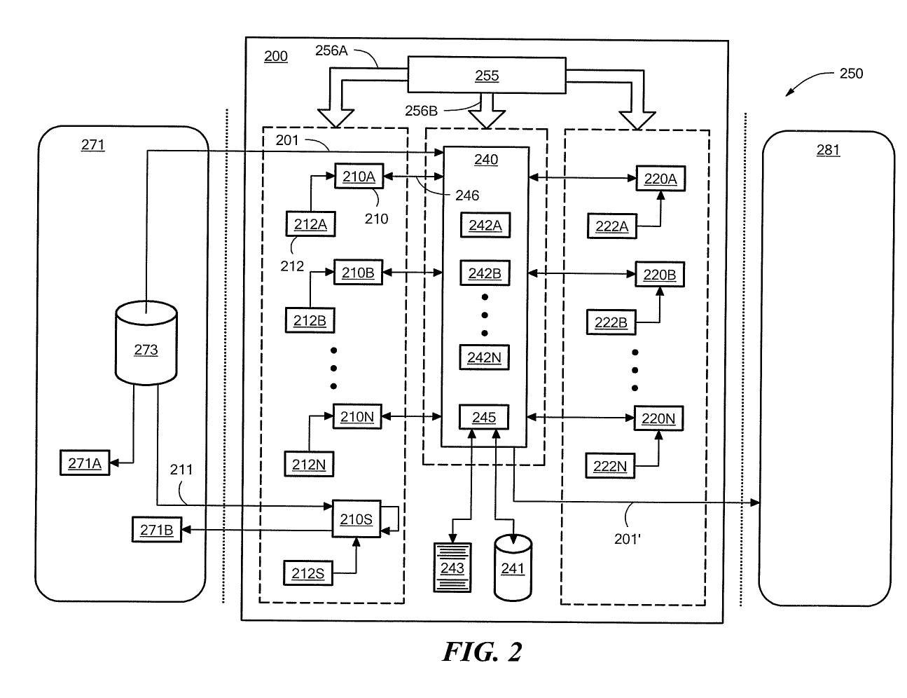

Referring now to FIG. 2, an embodiment of a data management system 250 includes data manager 200 including a plurality of first domain processes (generally designed by reference number 210) each associated with a first domain security policy (generally designed by reference number 212). First domain security processes 210 (for example, first domain security processes 210A, 210B-210N) are operable to provide first domain data 201 based on first domain security policies 212 (for example, first domain security policies 212A, 212B-212N). Data manager 200 further includes configuration process 255 to configure the first domain security processes 210 independently of each other and to configure data manager 200 independently of first domain security processes 210.

In a further embodiment, data manager 200 includes a plurality of second domain processes (generally designed by reference number 220) each associated with at least one second domain security policy (generally designed by reference number 222). Second domain security processes 220 (for example, second domain security processes 220A, 220B-220N) are operable to provide first domain security data 201′ based on second domain security policies 222 (for example, second domain security policies 222A, 222B-222N). Configuration process 255 further configures the second domain security processes 220 independently of each other and configures data manager 200 independently of second domain security processes 220.

In a further embodiment, data manager 200 includes data manager process 240 associated with one or more data manager security policies (generally designated by reference numeral 242). Here, data manager security process 240 is operable to provide first domain data 201 based on data manager security policy 242A, data manager security policy 242B, etc. up to N data manager security policies (242N). Data manager security policies 242 include security policies that may be needed or desired for cross-domain security but which are not specific to any particular domain or organization. To this end, a cross-domain authority may mandate and govern data manager security policies 242.

Data manager 200 may use various methods to process and render data 201 between first domain security processes 210 and data manager process 240. In some embodiments (shown in FIG. 2), data manager 200 serves as a gateway between first domain security processes 210 (a particular example of data flow between data manager 200 and first domain security processes 210 represented by arrows which are generally designated by reference numeral 246). For example, data manager 200 can receive first domain data 201 from first domain 271 and render the data 201 to first domain security process 210A which can process data 201 according to first domain security policy 212A. First domain security process 210A can render the result to data manager 200 which can render data to first domain process 210B, and so on, until at least a subset of the first domain security processes 210 have processed the data. Optionally, an audit process 245 can store some, none, or all of the data at different stages in data repository 241 and/or record security policy transactions in security log 243. In this way, data manager 200 may maintain a snapshot of the data at various stages of security processing, as well as security transactions, so that data may be recalled, confirmed, validated, or recreated at various stages as needed or desired.

In another embodiment, data manager 200 renders data 201 to respective tiers of related first and second domain security processes (for example, first domain security process 210A and second domain security process 210B can represent a tier of related security processes). Here, data manager 200 receives first domain 201 which is processed by first domain security process 210A and rendered to and processed by second domain security process 220A. Data is then received and processed at the next tier by first domain security process 210B and rendered to and processed by second domain security process 220B, etc. up to N tiers of security processes. In still another embodiment, data manager process 240 processes data according to one or more data manager security policies 242 related to the respective tiers of first domain security processes 210 and second domain security processes 220. Here, data manager security policies 242 are associated with cross-domain security practices not specific to any particular domain. Advantageously, related security practices of organization may be configured on data manager 100 at respective tiers. This can help organizations configure, compare, and cross-validate each other's related security practices so that, for example, organizations can ensure that outside data conforms to their own needs and desires. Yet another particular advantage of data comparing and cross-validating is the certain processing redundancies may be minimized or eliminated.

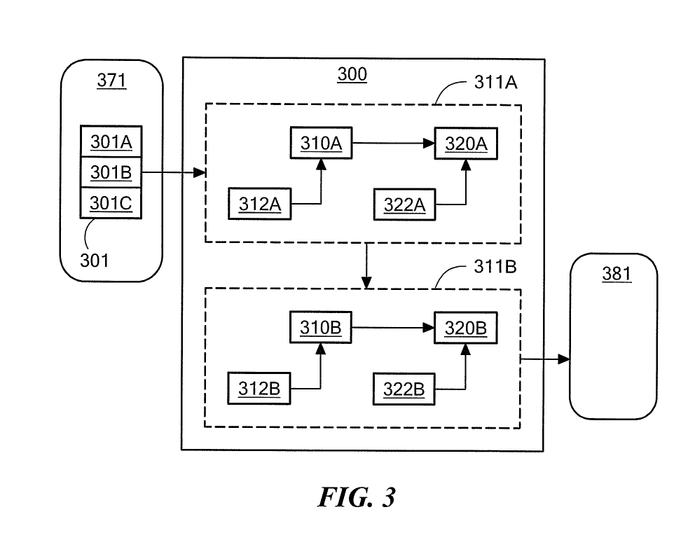

Referring now to FIG. 3, in a particular example of data access and service comparing, data 301 concerning evidence of a crime may be shared between first domain 371 which collected the evidence and second domain 181 which desires to use the evidence in a criminal investigation. Evidence includes data portion 301A, data portion 301B, and data portion 301C. Data portion 301A is the primary information needed by second domain 381, while first domain 371 does not want to share data portion 301B (although second domain 381 may benefit from the information), and second domain 381 is unable to use data portion 301C in the criminal investigation. Here, first domain security process 310A executes first domain security policy 312A including a data filter to remove data portion 301B. Second domain security process 320B executes second domain security policy 322B including a data filter to remove data portion 301C.

In data manager 300, first and second domain security processes (310A, 310B) and security policies (312A, 322A) form first tier 311A of related security practices. Within tier 311A, second domain 381 can review, compare, and cross-validate security policy 312A and request that first domain 371 modify it so that second data portion 301B is not removed because the data's possible utility. In response, first domain 371 can update first domain security policy 312A to add in some or all of data portion 301B. Optionally, a cross-domain authority may review, compare, and cross-validate first and second domain processes (310A, 320A) and domain policies (312A, 322A).

In second tier 311B related to formatting the data 301, first domain security process 310B executes first domain security policy 312B to format the data 301 according to the desires of first domain 371 and first domain security process 320B executes first domain security policy 322B to format the data 301 according to the desires of second domain 381. For example, although first domain security policy 312A may format the data 301 in a generally acceptable manner, second domain 381, upon review of first domain security policy 312B, may add or update first domain security policy 322B to reformat the data to add a field (301A₁) needed by second domain 381.

Referring again to FIG. 2, configuration process 255 configures first domain security processes 210 independently of each other (as designed by block arrow designated by reference numeral 256A). In some embodiments, configuration process 255 configures one of the first domain security processes (for example, first domain security process 210B) independently of another one of the first domain security processes (for example, first domain security process 210A) by updating first domain security process 210B without requiring reconfiguration of first domain security process 210A. In particular, configuration process 255 can update (for example, add, delete or modify) first domain security process 210B without the need to modify and/or operationally impact first domain security process 210A (or any other first domain security process 210). In this way, data manager 200 enables domain security processes 210 to be added, deleted, and/or modified as needed or desired without impacting operation of existing domain security processes 210 and/or policies 212. In other words, although security processes as a whole contribute to the overall security practices of a particular domain, security processes may be certified, tested, and/or administered individually. Such operational independence of domain security processes (which may be referred to as “decoupling” of the security processes) can promote fault tolerance in that malfunctions and/or execution errors in one of the security processes need not impact configuration or execution of other security processes.

Data manager 200 can use various methods to decouple first domain security processes 210 (and security policies 212). As by way of a non-limiting example, data manager 200 can use separate microprocessors (or separate processors of a multi-core processor) to independently execute each security policy 210. In the same or different embodiment, data manager 200 can use separate portions of memory to store data and execute security process functions. Optionally, data manager 200 can configure this memory as protected memory which only authorized processes can read or write to.

Configuration process 255 configures data manager 200 independently of first domain security processes 210 (as designed by block arrow designated by reference numeral 256B). In some embodiments, configuration process 255 configures data manager 200 by updating data manager process 240 (which can include configuration of auditor 245 and/or data manager security policies 242) without requiring reconfiguration of first domain security processes (for example, 210A). Configuration process 255 can also configure first domain security processes 210 independently of data manager 200 such that configuration of one or more first domain security processes 210 need not require reconfiguration of data manager 200.

In a further embodiment, data manager 200 includes first domain security process 210S associated with first domain security policy 212S. Here, first domain security process 210S provides first domain data 211 according to first domain security policy 212S. This can enable an organization in control of first domain 271 to secure data accessed between and among a first domain group 271A of first domain 271 and a second domain group 271B of first domain 271.

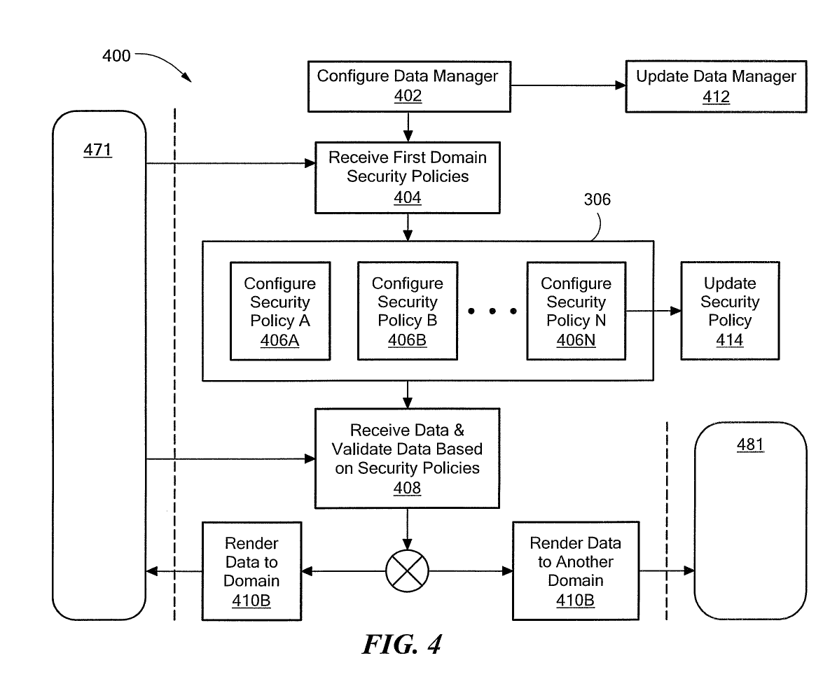

Referring now to FIG. 4, an embodiment of a method 400 includes, at 402, configuring a data manager (as may be the same or similar to data manager 100 described in conjunction with FIG. 1) to enable data security between a first domain (designated by reference numeral 471) and a second domain (designated by reference numeral 481) and, at 404, receiving domain security policies (as may be the same or similar to first domain security policies 112 described in conjunction with FIG. 1) associated with domain 471. The method 400 further includes, at step 406, configuring the received domain security policies independently of each other and independently of configuration of the data manager. More particularly, in a further embodiment of method 400, at step 406A, domain security policy A is configured, at step 406B, domain security policy B is configured, etc. up to configuration of n^{th} domain security policy at step 406N.

At 408, method 400 further includes receiving data from domain 471 and validating data based on domain security policies and, at 410A, rendering data to another domain 481 and/or to domain 471. In a further embodiment, method 400 includes, at step 412, updating the data manager without requiring reconfiguration of domain security policies. In the same or different embodiment, method 400 includes, at step 414, updating one or more domain security policies without requiring reconfiguration of other domain security policies and without requiring reconfiguration of the data manager.

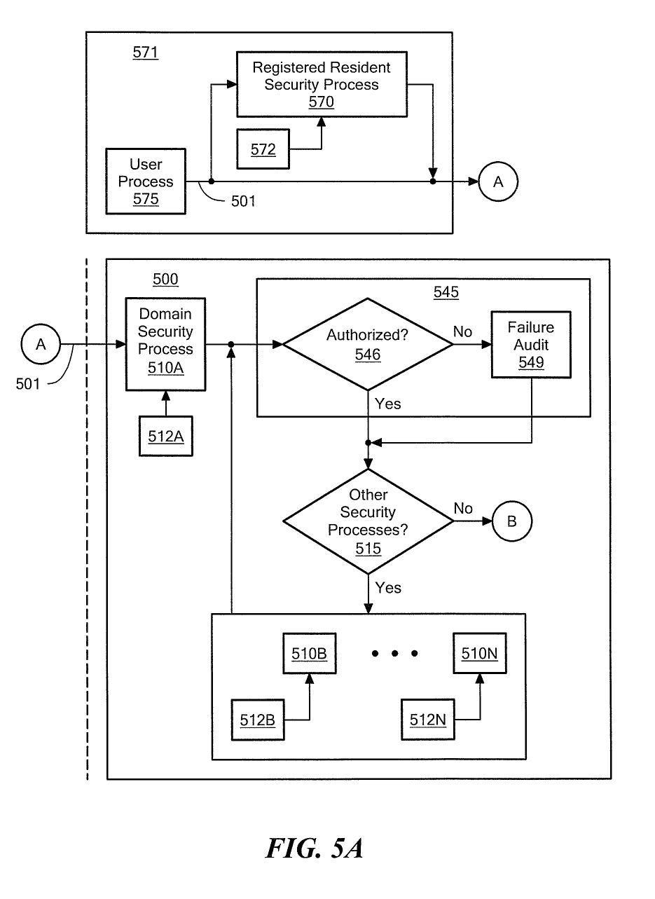

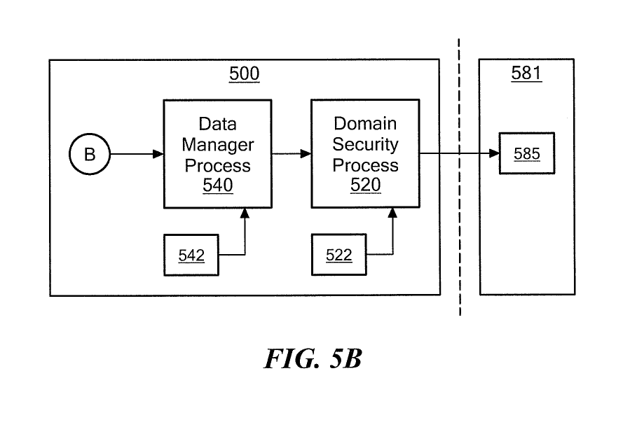

Referring now to FIG. 5A, in a particular exemplary operation of a cross-domain computing environment of the type which may incorporate the inventive concepts, systems, and methods described herein, a user process 575 resident in a first domain (designated by reference numeral 571) requests a service 585 from a second domain (designated by reference numeral 581). Data manager 500 receives data 501 including service request information (for example, user identification information, password information, permissions information, identification information for requested service, and/or domain information). At data manager 500, first domain security process 510A receives data 501 and executes first domain security policy 512A which determines (at least in part) whether or not user process 585 is authorized to access the second domain service 585. First domain security policy 512A can include rules to validate user information (for example, rules to validate authenticity of the user information) and to determine whether a particular user may access the requested second domain service 585. In a further embodiment, an auditor 545 renders auditing information. For example, at 545, if the service request is not authorized, the auditor 545 can render a failure audit 549.

At 515, if data manager 500 includes other domain security processes, then first domain security policy 510B receives data 501 (or a derivative of the data processed by first domain security process 510A) and executes first domain security policy 512B which can include rules to validate domain information and to determine whether a particular domain may access the requested second domain service 585. Other first domain security processes (as represented by reference number 510N) may execute security policies (as represented by reference number 512N) to further authorize the user process 575. In this way, security policies can be segregated and executed independently of each other as well as of policies associated with other domains (such as second domain 581). Advantageously, independent execution of security policies can enable independent configuring (for example, updating or testing) of a particular security policy without operationally impacting other security policies. Furthermore, independent execution of security policies can improve fault tolerance of a cross-domain data management system and associated security practices and mechanisms.

Referring now to FIG. 5B, in another embodiment, if data manager 500 does not include any other first domain security processes or if all security policies associated with first domain 571 have been executed, data manager 500 can include one or more data management processes (generally designed reference numeral 540) to execute one or more data manager security policies (generally designated by reference numeral 542) and/or one or more second domain security processes (generally designated by reference numeral 520) to execute second domain security policies (generally designated by reference numeral 522) associated with second domain 581. In this way, data manager 500 enables cross-domain security policies 542 which may not be specific to another particular domain as well as domain-specific security policies (that is, domain security policies associated with domain 571 and domain 581).

Referring back to FIG. 5A, in the same or different embodiment, a security process 570 resident in first domain 571 receives the data 501 and determines whether or not user process 575 may request service 585 in second domain 581 based on domain information 572. Security process 570 includes domain-specific security information resident in domain 571 and which may be associated with domain security process 510.

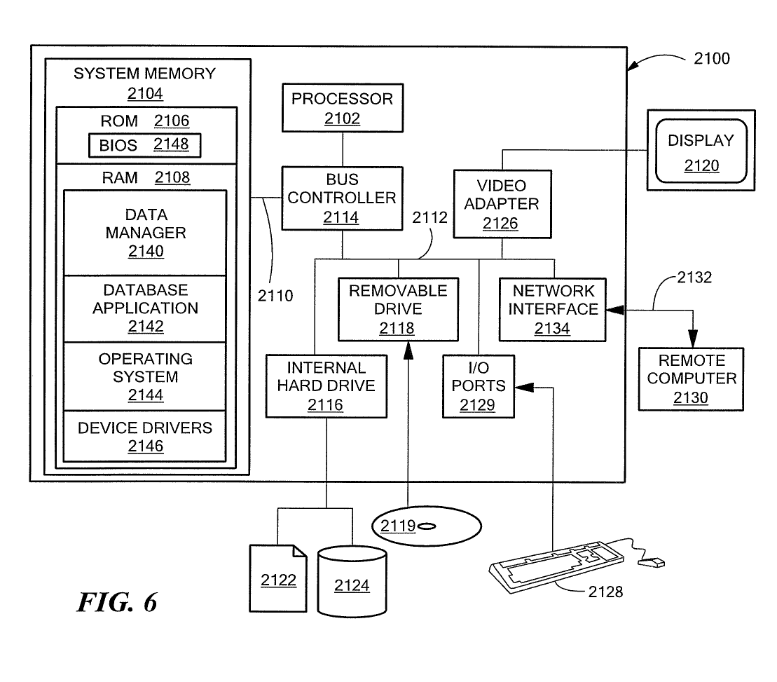

FIG. 6 illustrates a computer 2100 suitable for supporting the operation of an embodiment of the inventive concepts, systems, and methods described herein. The computer 2100 includes a processor 2102, for example, a desktop processor, laptop processor, server and workstation processor, and/or embedded and communications processor. As by way of a non-limiting example, processor 2102 may include an Intel® Core™ i7, i5, or i3 processor manufactured by the Intel Corporation of Santa Clara, Calif. However, it should be understood that the computer 2100 may use other microprocessors. Computer 2100 can represent any server, personal computer, laptop, or even a battery-powered mobile device such as a hand-held personal computer, personal digital assistant, or smart phone.

Computer 2100 includes a system memory 2104 which is connected to the processor 2102 by a system data/address bus 2110. System memory 2104 includes a read-only memory (ROM) 2106 and random access memory (RAM) 2108. The ROM 2106 represents any device that is primarily read-only including electrically erasable programmable read-only memory (EEPROM), flash memory, etc. RAM 2108 represents any random access memory such as Synchronous Dynamic Random Access Memory (SDRAM). The Basic Input/Output System (BIOS) 2148 for the computer 2100 is stored in ROM 2106 and loaded into RAM 2108 upon booting.

Within the computer 2100, input/output (I/O) bus 2112 is connected to the data/address bus 2110 via a bus controller 2114. In one embodiment, the I/O bus 2112 is implemented as a Peripheral Component Interconnect (PCI) bus. The bus controller 2114 examines all signals from the processor 2102 to route signals to the appropriate bus. Signals between processor 2102 and the system memory 2104 are passed through the bus controller 2114. However, signals from the processor 2102 intended for devices other than system memory 2104 are routed to the I/O bus 2112.

Various devices are connected to the I/O bus 2112 including internal hard drive 2116 and removable storage drive 2118 such as a CD-ROM drive used to read a compact disk 2119 or a floppy drive used to read a floppy disk. The internal hard drive 2116 is used to store data, such as in files 2122 and database 2124. Database 2124 includes a structured collection of data, such as a relational database. A display 2120, such as a cathode ray tube (CRT), liquid-crystal display (LCD), etc. is connected to the I/O bus 2112 via a video adapter 2126.

A user enters commands and information into the computer 2100 by using input devices 2128, such as a keyboard and a mouse, which are connected to I/O bus 2112 via I/O ports 2129. Other types of pointing devices that may be used include track balls, joy sticks, and tracking devices suitable for positioning a cursor on a display screen of the display 2120.

Computer 2100 may include a network interface 2134 to connect to a remote computer 2130, an intranet, or the Internet via network 2132. The network 2132 may be a local area network or any other suitable communications network.

Computer-readable modules and applications 2140 and other data are typically stored on memory storage devices, which may include the internal hard drive 2116 or the compact disk 2119, and are copied to the RAM 2108 from the memory storage devices. In one embodiment, computer-readable modules and applications 2140 are stored in ROM 2106 and copied to RAM 2108 for execution, or are directly executed from ROM 2106. In still another embodiment, the computer-readable modules and applications 2140 are stored on external storage devices, for example, a hard drive of an external server computer, and delivered electronically from the external storage devices via network 2132.

The computer-readable modules 2140 may include compiled instructions for implementing embodiments directed to cross-domain security described herein. In a further embodiment, the computer 2100 may execute cross-domain security on one or more processors. For example, a first processor to execute a first security policy (as may be the same or similar to first domain security policy 212A described in conjunction with FIG. 2) and a second processor to execute a second security policy (as may be the same or similar to first domain security policy 222B described in conjunction with FIG. 2). Furthermore, the first and second processors may be respective processors of a dual-core processor. Alternatively, the first and second processor may respective first and second computing devices.

The computer 2100 may execute a database application 2142, such as Oracle™ database from Oracle Corporation, to model, organize, and query data stored in database 2124. The data may be used by the computer-readable modules and applications 2140 information associated with the data (e.g., domain data) may be rendered over the network 2132 to a remote computer 2130 and systems.

In general, the operating system 2144 executes computer-readable modules and applications 2140 and carries out instructions issued by the user. For example, when the user wants to execute a computer-readable module 2140, the operating system 2144 interprets the instruction and causes the processor 2102 to load the computer-readable module 2140 into RAM 2108 from memory storage devices. Once the computer-readable module 2140 is loaded into RAM 2108, the processor 2102 can use the computer-readable module 2140 to carry out various instructions. The processor 2102 may also load portions of computer-readable modules and applications 2140 into RAM 2108 as needed. The operating system 2144 uses device drivers 2146 to interface with various devices, including memory storage devices, such as hard drive 2116 and removable storage drive 2118, network interface 2134, I/O ports 2129, video adapter 2126, and printers.

Having described preferred embodiments which serve to illustrate various concepts, structures and techniques which are the subject of this patent, it will now become apparent to those of ordinary skill in the art that other embodiments incorporating these concepts, structures and techniques may be used. Accordingly, it is submitted that that scope of the patent should not be limited to the described embodiments but rather should be limited only by the spirit and scope of the following claims.

What is claimed is:

1. A data management system, comprising:
a microprocessor; and
a data manager executing on the microprocessor and communicatively coupled to a first domain and a second domain, comprising:
a first domain security process associated with a first domain security policy and operable to provide access to first domain data based on the first domain security policy; and
a second domain security process associated with a second domain security policy and operable to provide access to first domain data based on the second domain security policy.

2. The system claim 1, wherein the first domain security policy is associated with first domain security information received from the first domain from a security process resident in the first domain.

3. The system claim 2, wherein the second domain security policy is associated with second domain security information received from the second domain from a security process resident in the second domain.

4. The system claim 1, further comprising a data manager process communicatively coupled to the first domain process and the second domain process and configured to provide access to the first domain data based on a data manager security policy.

5. The system claim 1, wherein the first domain security process comprises a plurality of individually configured first domain security processes.

6. The system of claim 1, wherein the first domain security policy is related to the second domain security policy.

7. The system of claim 1, wherein the data manager provides data access to at least one of the first domain or the second domain.

8. A system, comprising:
a microprocessor; and
a data manager executing on the microprocessor and to couple of a first domain and a second domain, comprising:
a plurality of domain security processes to receive of a plurality of domain security policies associated with the first domain and to enable access to first domain data based on the plurality of domain security policies; and
a configuration process to configure the domain security processes independently of each other and to configure the data manager independently of the domain security processes.

9. The system of claim 8, wherein the configuration process enables update of one of the domain security processes without requiring reconfiguration of another domain security process.

10. The system of claim 9, wherein said domain security process update includes addition, deletion, or modification.

11. The system of claim 8, wherein the configuration process enables update of one of the domain security processes without requiring reconfiguration of the data manager.

12. The system of claim 8, wherein the domain security processes are first domain security processes and the domain security policies are first domain security policies, the data manager further comprising:
a plurality of second domain security processes to receive of a plurality of second domain security policies associated with the second domain and to enable access to first domain data based on the plurality of second domain security policies.

13. The system of claim 12, wherein one of the second domain security policies is related to one of the first domain security policies.

14. The system of claim 13, wherein the configuration process enables comparing of the related first and second domain security policies.

15. A method, comprising:
configuring a data manager to enable data security between a first domain and a second domain;
in the data manager, receiving a plurality of first domain security policies associated with the first domain;
configuring the first domain security policies independently of each other and independently of said configuration of the data manager; and
receiving first domain data and validating the first domain data based on the plurality of first domain security policies and rendering the first domain data to the second domain.

16. The method of claim 15, wherein said configuring the first domain security policies independently of each other comprises adding, deleting, or modifying one of the first domain policies without requiring reconfiguration of another one of the first domain security policies.

17. The method of claim 15, wherein said configuring the first domain security policies independently of said configuring of the data manager comprises adding, deleting, or modifying one of the first domain policies without requiring reconfiguration of the data manager

18. The method of 15, further comprising:
receiving a plurality of second domain security policies associated with the second domain, said validation of the first domain data further comprising validating the first domain data based on the plurality of second domain security policies.

19. The method of claim 18, wherein one of the second domain security policies is related to one of the first domain security policies, further comprising:
comparing configuration of the related first and second domain security policies.
